(19) United States
(12) Patent Application Publication
(10) Pub. No.: US 2025/0108765 A1
(43) Pub. Date: Apr. 3, 2025

(54) PORTABLE VEHICLE STORAGE SYSTEM, PORTABLE VEHICLE LADDER SYSTEM, VEHICLE MOUNTED DEVICE, PROCESS, AND METHOD OF USE

(71) Applicants: Derrick Peterson, Cleveland, MO (US); Connor Peterson, Louisburg, KS (US); Jeff Schneider, Rogersville, MO (US)

(72) Inventors: Derrick Peterson, Cleveland, MO (US); Connor Peterson, Louisburg, KS (US); Jeff Schneider, Rogersville, MO (US)

(21) Appl. No.: 18/900,722

(22) Filed: Sep. 28, 2024

Related U.S. Application Data
(60) Provisional application No. 63/540,975, filed on Sep. 28, 2023.

(51) Int. Cl. B60R 9/06; B60R 9/042

(52) U.S. Cl. CPC B60R 9/06; B60R 9/0423

(57) ABSTRACT

A portable vehicle storage system, a portable vehicle ladder transportation system, a vehicle mounted device, process of transporting large items, and methods of use are presented. More specifically, and without limitation, the present disclosure relates to a system which attaches to the tow hitch of a vehicle and provides for easy stowage and transport of large apparatus, such as ladders and the like. The disclosure provides a ladder rack which hooks into the tow hitch of a vehicle for storage and transportation of multi-function ladders, vertically behind a vehicle.

### CROSS-REFERENCE TO RELATED APPLICATIONS

The present application claims priority to the U.S. Provisional Patent Application No. 63/540,975 which was filed on Sep. 28, 2023, which is hereby incorporated by reference herein in its entirety, including any figures, tables, or drawings.

### FIELD OF THE INVENTION

This disclosure relates to a portable vehicle storage system, a portable vehicle ladder transportation system, a vehicle mounted device, process of transporting large items, and methods of use. More specifically, and without limitation, the present disclosure relates to a system which attaches to the tow hitch of a vehicle and provides for easy stowage and transport of large apparatus, such as ladders and the like.

### BACKGROUND OF THE INVENTION

Vehicles are well known in the art. The use of recreational vehicles, such as campers, vans, mobile motor homes, vehicle hauled camper compartments, and similarly sized vehicles, continue to enjoy wide popularity. Vehicle storage is more critical than ever for various types of vehicles. More specifically, in the field of towing or hauling, more particularly those methods and devices used for a ladder, a bicycle, tools, a motorcycle, many different types of vehicles, trailers and carriers have been developed.

These devices fall generally into three categories: cargo vehicles, carriers and trailers. Cargo vehicles include pickup trucks and commercial vans. Carriers attach rigidly to the tow vehicle and the entire payload is supported by the vehicle. Trailers typically attach to the tow vehicle by means of a conventional ball hitch, and both the trailer axle and the vehicle share the payload. Trailers are well known in the art as an added means of vehicle storage and for use in transporting large equipment, materials, and the like. Trailer hitches are typically used for hauling trailers and the associated mounting systems, and more.

Ladders are a piece of equipment commonly used in construction, around homes and businesses, in landscaping, and in places where a user needs to access a higher vertical position. Storing ladders and getting ladders to a desired location is very challenging in the state of the art due to the size of ladders. Transporting and/or storing ladders and the like is difficult, oftentimes resulting in damage to property or injury.

Thus, there is a long-felt need in the art for a portable vehicle storage system, a portable vehicle ladder transportation system, a vehicle mounted device, process of transporting large items, and methods of use which improves upon the state of the art and improves upon the state of the art. More specifically, a convenient and easy to use ladder transportation system which easily connects and operates to a trailer hitch is needed in the state of the art.

The disclosure herein provides these advantages and others as will become clear from the specification and claims provided.

### SUMMARY OF THE INVENTION

A portable vehicle storage system, a portable vehicle ladder transportation system, a vehicle mounted device, process of transporting large items, and methods of use are presented. Said another way, a portable vehicle storage system, a portable vehicle ladder transportation system, a vehicle mounted device, process of transporting large items, and methods of use. More specifically, and without limitation, the present disclosure relates to a system which attaches to the tow hitch of a vehicle and provides for easy stowage and transport of large apparatus, such as ladders and the like.

Thus, it is a primary object of the disclosure to provide a portable vehicle storage system, a portable vehicle ladder transportation system, a vehicle mounted device, process of transporting large items, and methods of use that improves upon the state of the art.

Another object of the disclosure is to provide a portable vehicle storage system, a portable vehicle ladder transportation system, a vehicle mounted device, process of transporting large items, and methods of use that attach to the receiver hitch of a vehicle.

Yet another object of the disclosure is to provide a portable vehicle storage system, a portable vehicle ladder transportation system, a vehicle mounted device, process of transporting large items, and methods of use that can hold a plurality of ladders.

Another object of the disclosure is to provide a portable vehicle storage system, a portable vehicle ladder transportation system, a vehicle mounted device, process of transporting large items, and methods of use that can transport a plurality of ladders.

Yet another object of the disclosure is to provide a portable vehicle storage system, a portable vehicle ladder transportation system, a vehicle mounted device, process of transporting large items, and methods of use that quickly can be utilized to attach a ladder.

Another object of the disclosure is to provide a portable vehicle storage system, a portable vehicle ladder transportation system, a vehicle mounted device, process of transporting large items, and methods of use that are quick to remove a ladder.

Yet another object of the disclosure is to provide a portable vehicle storage system, a portable vehicle ladder transportation system, a vehicle mounted device, process of transporting large items, and methods of use that are easy to use.

Another object of the disclosure is to provide a portable vehicle storage system, a portable vehicle ladder transportation system, a vehicle mounted device, process of transporting large items, and methods of use that are safe to use.

Yet another object of the disclosure is to provide a portable vehicle storage system, a portable vehicle ladder transportation system, a vehicle mounted device, process of transporting large items, and methods of use that are safe for a user to access and store.

Another object of the disclosure is to provide a portable vehicle storage system, a portable vehicle ladder transportation system, a vehicle mounted device, process of transporting large items, and methods of use that provides for quick loading and unloading.

Yet another object of the disclosure is to provide a portable vehicle storage system, a portable vehicle ladder transportation system, a vehicle mounted device, process of transporting large items, and methods of use that provides for easily delivering ladders to a location.

Another object of the disclosure is to provide a portable vehicle storage system, a portable vehicle ladder transportation system, a vehicle mounted device, process of transporting large items, and methods of use that provides a plurality of storage locations which can be reached easily.

Yet another object of the disclosure is to provide a portable vehicle storage system, a portable vehicle ladder transportation system, a vehicle mounted device, process of transporting large items, and methods of use that can be used with any vehicle.

Another object of the disclosure is to provide a portable vehicle storage system, a portable vehicle ladder transportation system, a vehicle mounted device, process of transporting large items, and methods of use that can haul a plurality of ladders.

Yet another object of the disclosure is to provide a portable vehicle storage system, a portable vehicle ladder transportation system, a vehicle mounted device, process of transporting large items, and methods of use that can haul a plurality of bikes.

Another object of the disclosure is to provide a portable vehicle storage system, a portable vehicle ladder transportation system, a vehicle mounted device, process of transporting large items, and methods of use that can carry various large equipment.

Yet another object of the disclosure is to provide a portable vehicle storage system, a portable vehicle ladder transportation system, a vehicle mounted device, process of transporting large items, and methods of use that fold into a small space for easy storage.

Another object of the disclosure is to provide a portable vehicle storage system, a portable vehicle ladder transportation system, a vehicle mounted device, process of transporting large items, and methods of use that provide locking mechanisms for security.

Yet another object of the disclosure is to provide a portable vehicle storage system, a portable vehicle ladder transportation system, a vehicle mounted device, process of transporting large items, and methods of use that stores equipment off of the ground.

Another object of the disclosure is to provide a portable vehicle storage system, a portable vehicle ladder transportation system, a vehicle mounted device, process of transporting large items, and methods of use that are easy to travel with.

Yet another object of the disclosure is to provide a portable vehicle storage system, a portable vehicle ladder transportation system, a vehicle mounted device, process of transporting large items, and methods of use that are safe to use.

Yet another object of the disclosure is to provide a portable vehicle storage system, a portable vehicle ladder transportation system, a vehicle mounted device, process of transporting large items, and methods of use that are quick and efficient.

Yet another object of the disclosure is to provide a portable vehicle storage system, a portable vehicle ladder transportation system, a vehicle mounted device, process of transporting large items, and methods of use that is robust.

Another object of the disclosure is to provide a portable vehicle storage system, a portable vehicle ladder transportation system, a vehicle mounted device, process of transporting large items, and methods of use that saves time for a user.

Yet another object of the disclosure is to provide a portable vehicle storage system, a portable vehicle ladder transportation system, a vehicle mounted device, process of transporting large items, and methods of use that saves energy.

Another object of the disclosure is to provide a portable vehicle storage system, a portable vehicle ladder transportation system, a vehicle mounted device, process of transporting large items, and methods of use that are high quality.

Yet another object of the disclosure is to provide a portable vehicle storage system, a portable vehicle ladder transportation system, a vehicle mounted device, process of transporting large items, and methods of use that provides a plurality of adjustment features.

Yet another object of the disclosure is to provide a portable vehicle storage system, a portable vehicle ladder transportation system, a vehicle mounted device, process of transporting large items, and methods of use that provide for hinging features.

Yet another object of the disclosure is to provide a portable vehicle storage system, a portable vehicle ladder transportation system, a vehicle mounted device, process of transporting large items, and methods of use that provide a plurality of access features.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a perspective view of the portable vehicle storage system, a portable vehicle ladder transportation system, a vehicle mounted device, process of transporting large items; the view showing a stem; the view showing a main body; the view showing a lower support; the view showing a plurality of upper supports; the view showing a locking mechanism in an engaged position.

FIG. 2 is a perspective view of the portable vehicle storage system, a portable vehicle ladder transportation system, a vehicle mounted device, process of transporting large items; the view showing a stem; the view showing a main body; the view showing a lower support; the view showing a plurality of upper supports; the view showing a locking mechanism in an engaged position.

FIG. 3 is an exploded perspective view of the portable vehicle storage system, a portable vehicle ladder transportation system, a vehicle mounted device, process of transporting large items; the view showing a stem; the view showing a main body; the view showing a lower support; the view showing a plurality of upper supports; the view showing a locking mechanism in an engaged position.

FIG. 4 is a perspective view of the plurality of upper supports.

FIG. 5 is a perspective view of the plurality of upper supports.

FIG. 6 is a perspective view of a latch.

FIG. 7 is a perspective view of a latch.

FIG. 8 is a perspective view of the main body.

FIG. 9 is a perspective view of the main body.

FIG. 10 is a perspective view of the lower support.

FIG. 11 is a perspective view of the lower support.

FIG. 12 is a perspective view of the stem.

FIG. 13 is a perspective view of the stem.

FIG. 14 is a perspective view of a holed tube.

FIG. 15 is a perspective view of a holed tube.

FIG. 16 is a perspective view of a formed bracket.

FIG. 17 is a perspective view of a formed bracket.

FIG. 18 is a perspective view of a formed bracket.

FIG. 19 is a perspective view of a short holed tube.

FIG. 20 is a perspective view of an angled long tube.

FIG. 21 is a perspective view of an angled long tube.

FIG. 22 is a perspective view of an angled short tube.

FIG. 23 is a perspective view of an angled short tube.

FIG. 24 is a perspective view of a tube.

FIG. 25 is a perspective view of a holed short tube.

FIG. 26 is a perspective view of an end cap with a ring.

FIG. 27 is a perspective view of an end cap.

FIG. 28 is a perspective view of a cover plate.

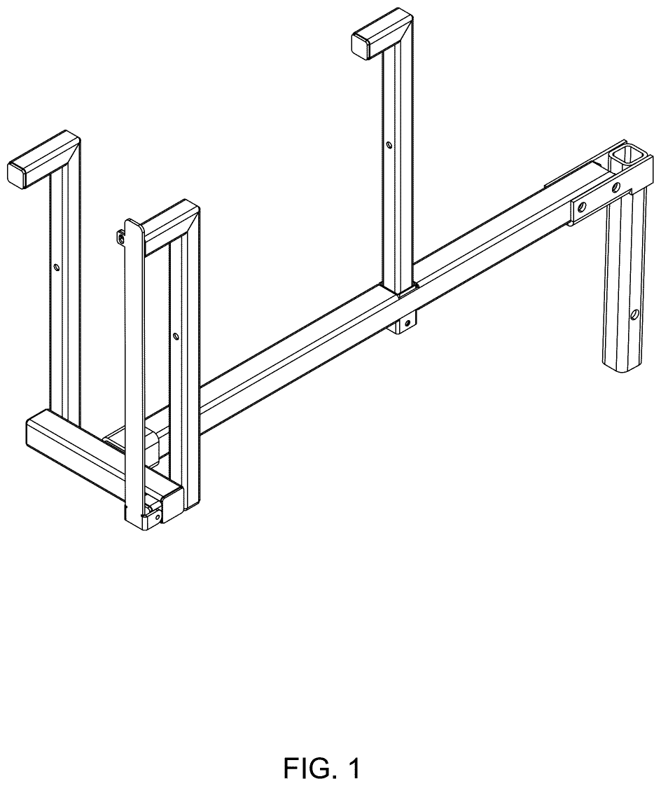

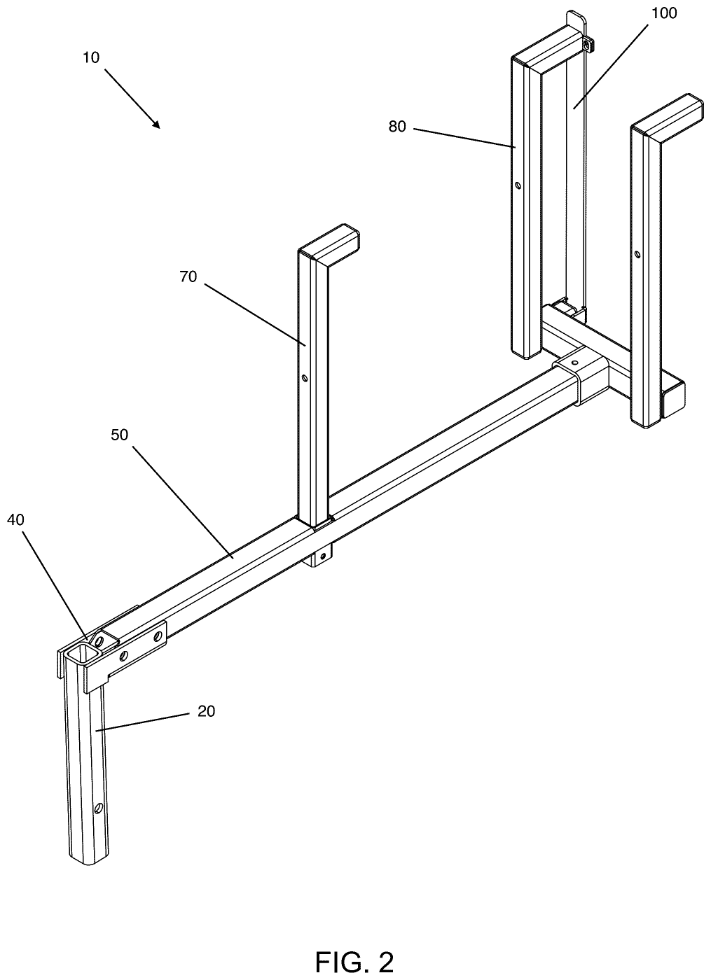

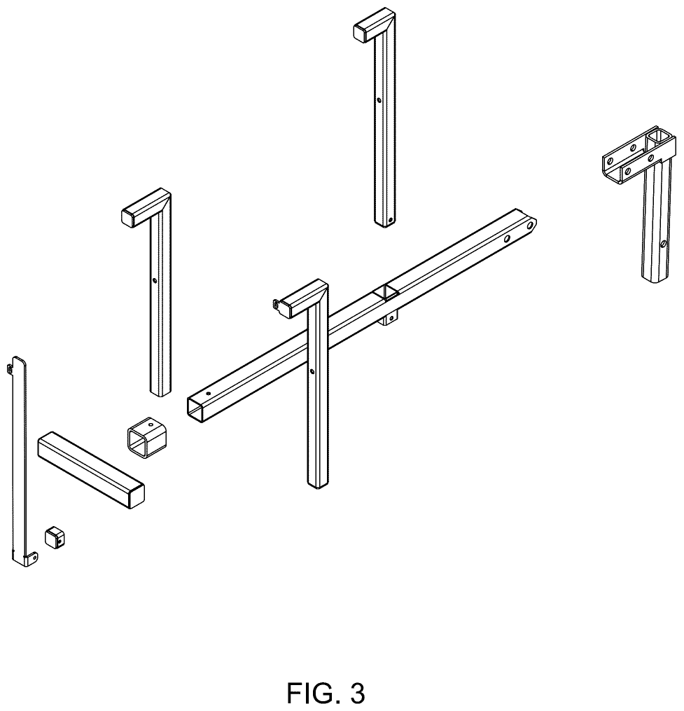

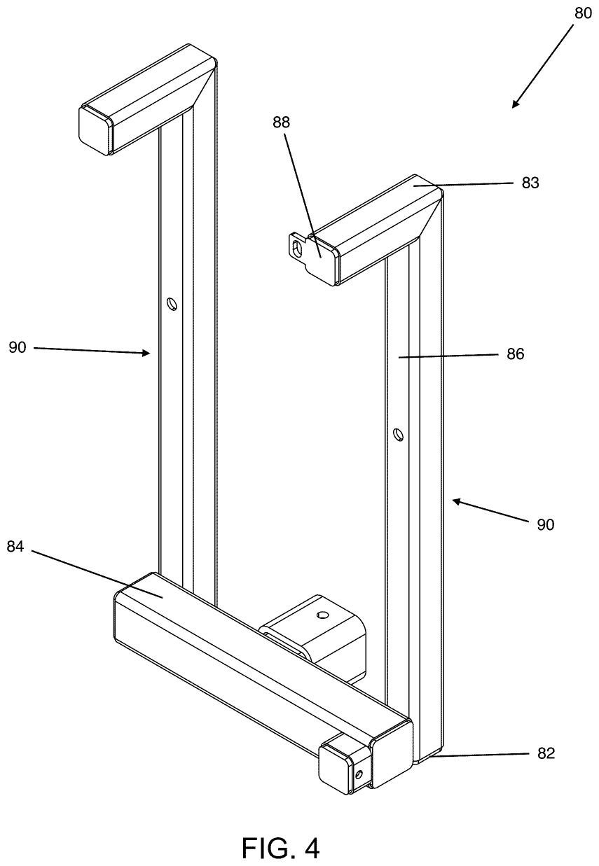

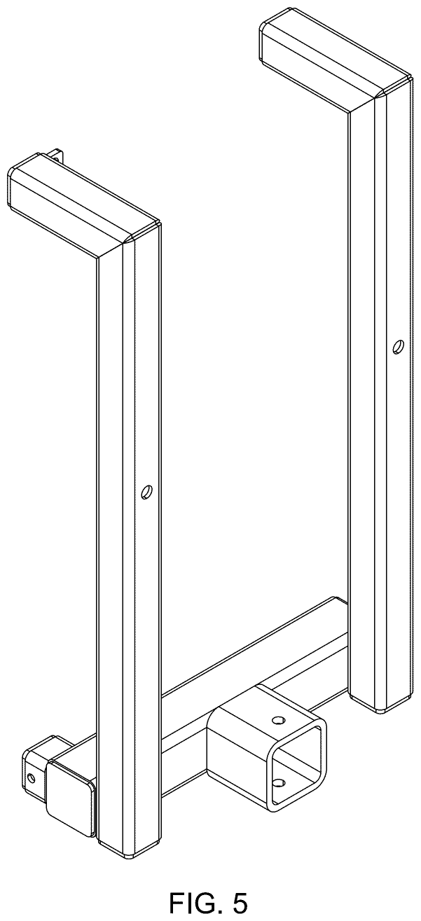

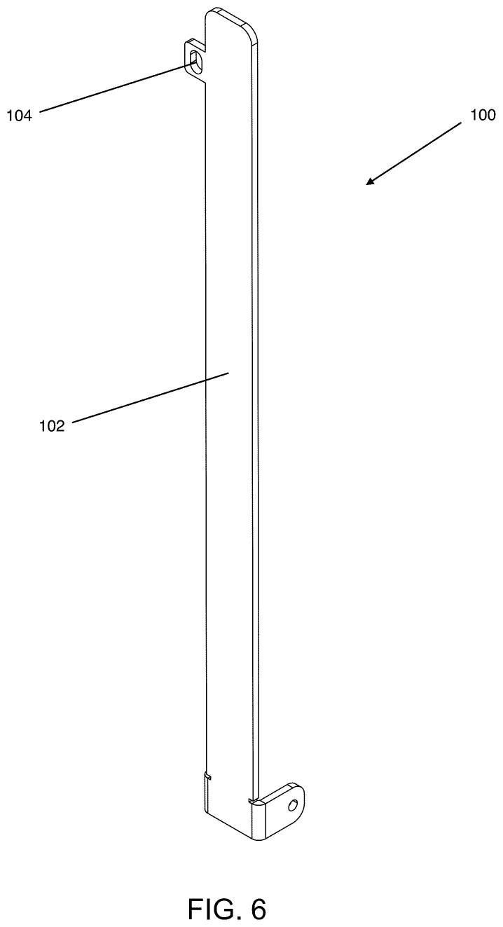

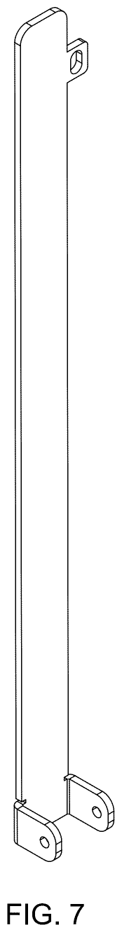

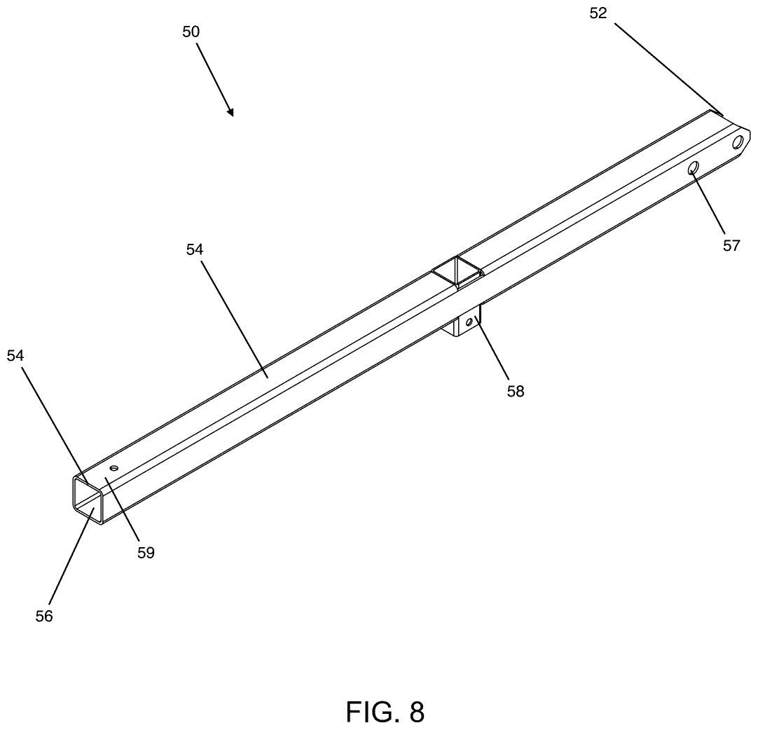

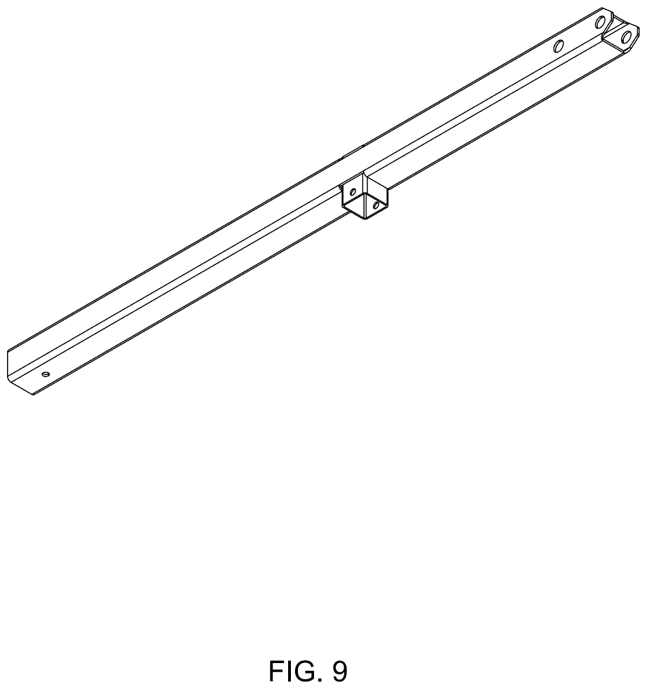

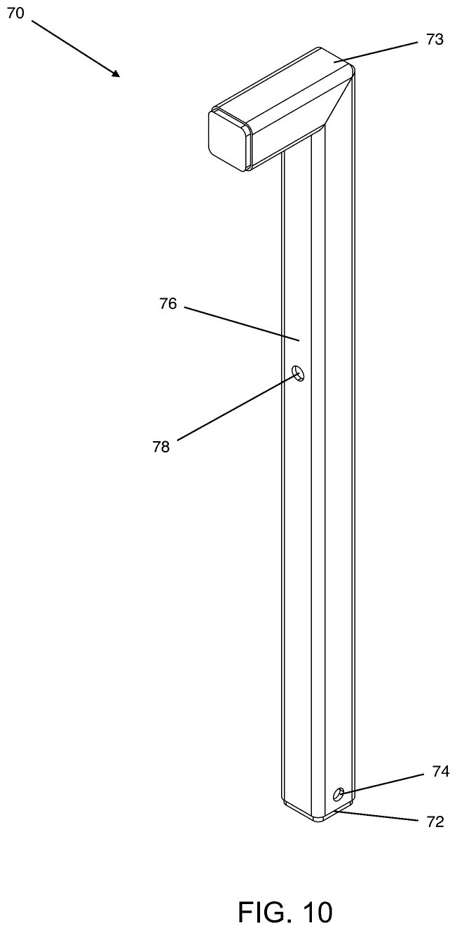

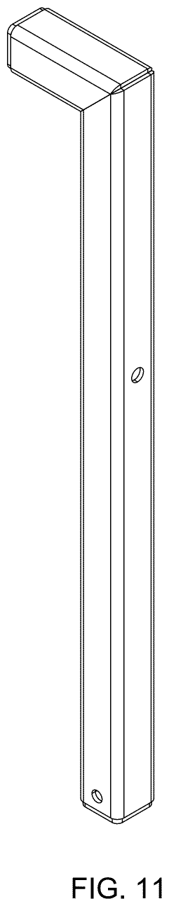

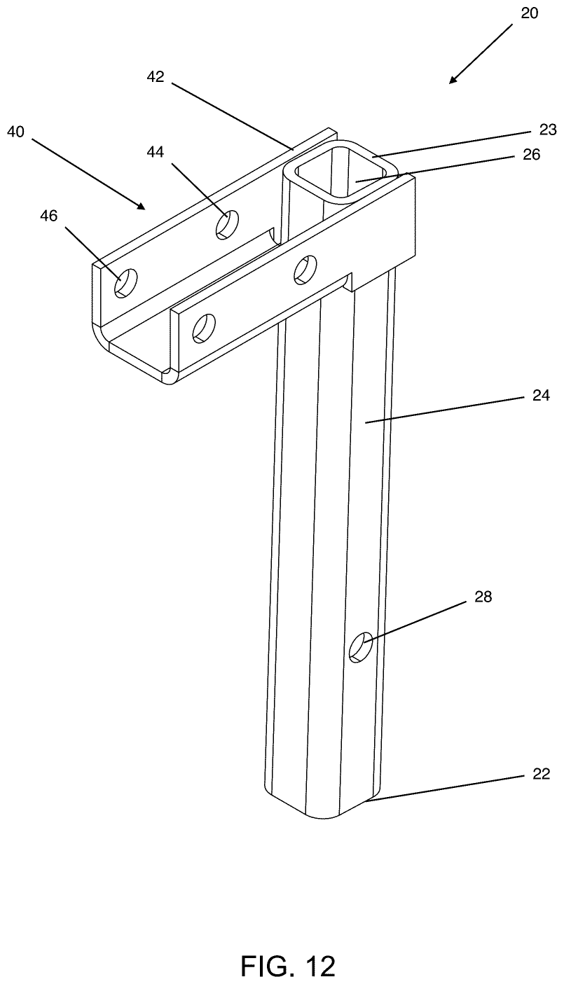

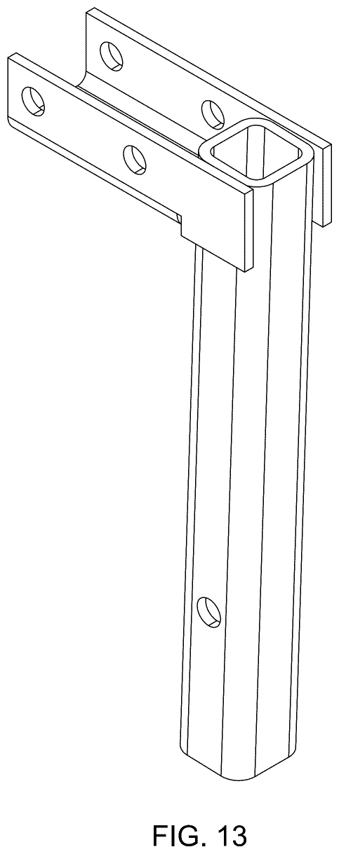

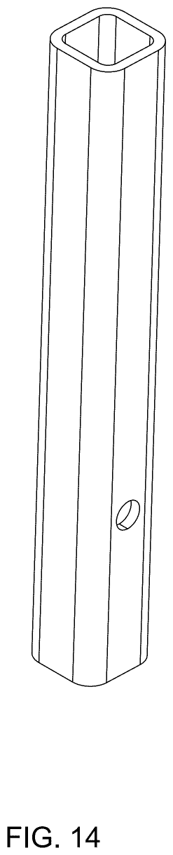

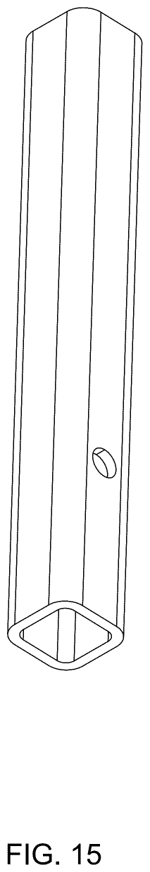

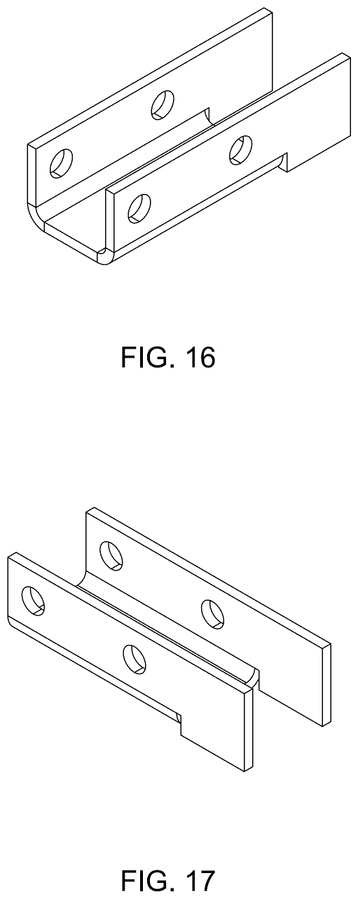

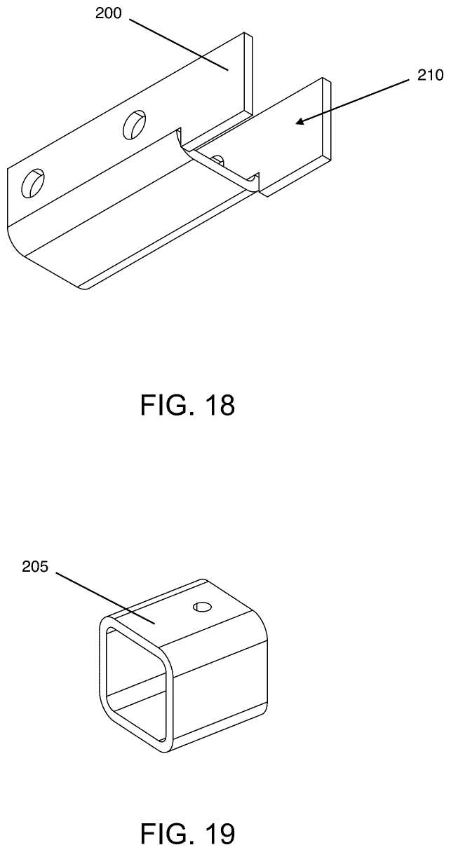

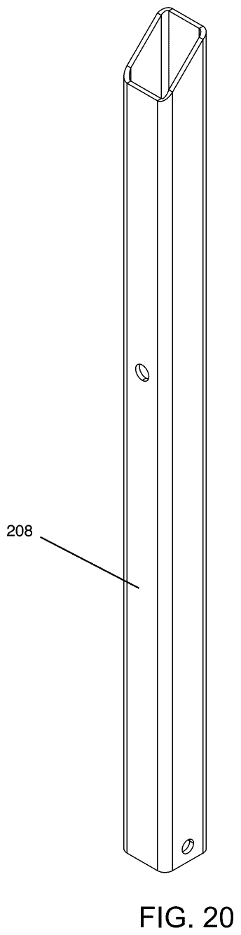

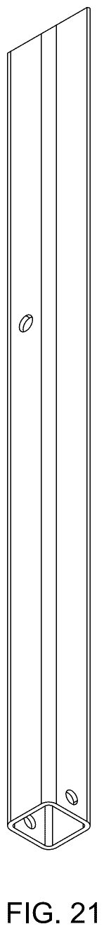

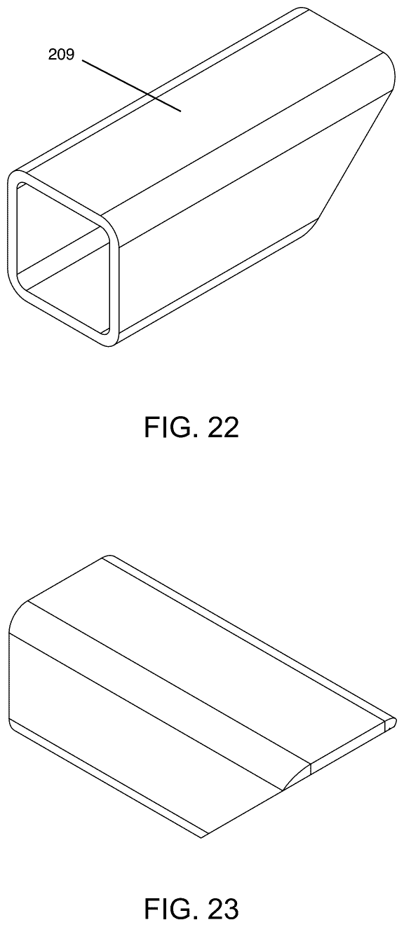

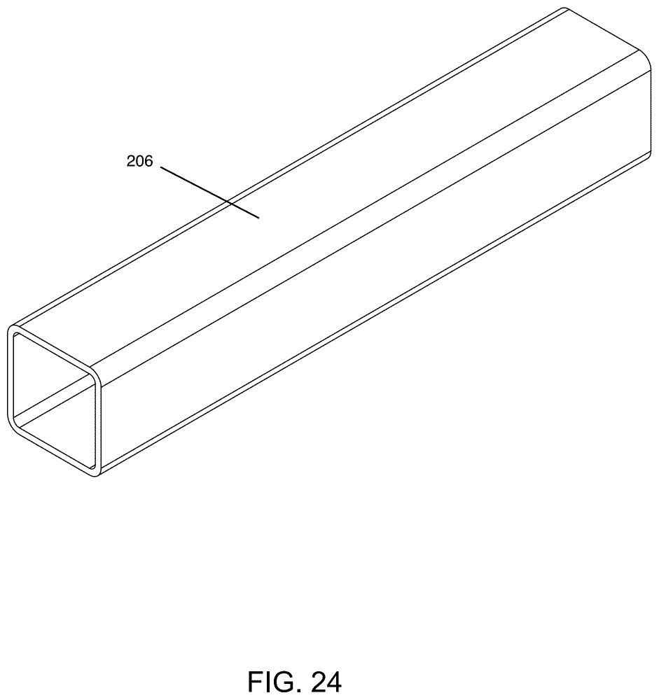

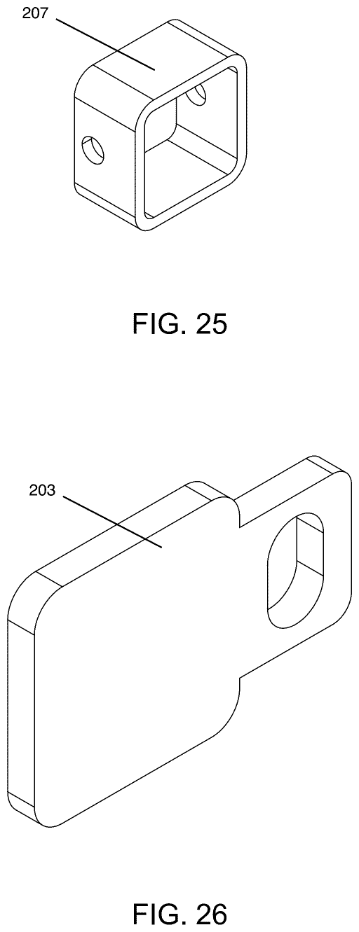

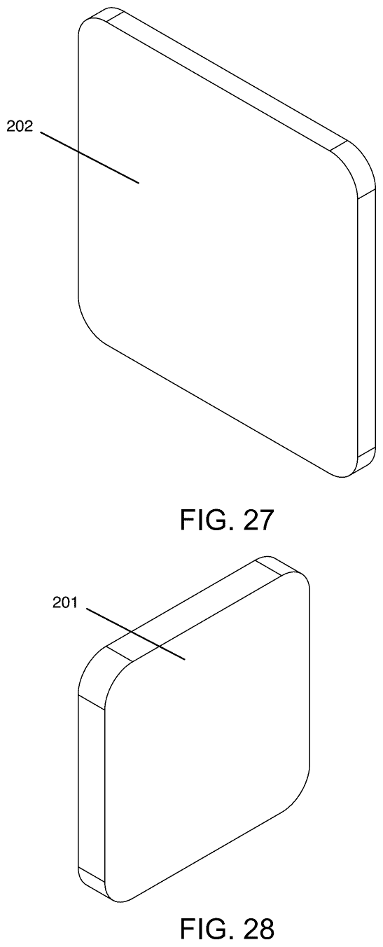

### DESCRIPTION

In the following detailed description, reference is made to the accompanying drawings which form a part hereof, and in which is shown by way of illustration specific embodiments in which the disclosure may be practiced.

These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure.

Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

### System:

With reference to the figures, a portable vehicle storage system, a portable vehicle ladder transportation system, a vehicle mounted device, process of transporting large items, and methods of use 10 are presented. a portable vehicle storage system, a portable vehicle ladder transportation system, a vehicle mounted device, process of transporting large items, and methods of use 10 (hereafter referred to as “ladder hitch system”, “ladder transport device”, “stowage system”, “transport system”, or simply “system”) is formed of any suitable size, shape and design.

In the arrangement shown, as one example, the main structure of system 10 includes a vehicle, a hitch, a plurality of ladders, a first location 17, a second location 18, a stem 20, an operable attachment 40, a main body 50, a lower support 70, and an upper support 80, among other components, features, and functionality.

Furthermore, system 10 may also include a plurality of attachments, a plurality of wired connections, a plurality of sensors, an onboard computing system, a bluetooth connection, a plurality of cameras for monitoring and security purposes, and communication and control components, among other components, features, and functionality.

In the arrangement shown, as one example, system 10 is configured to provide a ladder rack which attaches to the receiver hitch on a vehicle, such as a truck or car. In the arrangement shown, as one example, system 10 may hold a single ladder, two ladders, three ladders, four ladders, five ladders, six ladders, seven ladders, or more. Furthermore, system 10 may also be adjusted and or configured to hold a plurality of bicycles and/or other equipment, and the like.

Furthermore, and in the arrangement shown, system 10 is configured to attach to the back of a vehicle and/or at the location of the tow hitch. System 10 is configured to provide for optimization of time, time savings in loading and unloading. Furthermore, system 10 is configured to be easy to use and adjust and easy to load and unload and easy to lock and unlock for securement purposes.

Furthermore, and in the arrangement shown as one example, system 10 is configured at easy to access height for access. Said another way, system 10 provides an easy to use system which prevents injury, improves safety, and improves access, and improves upon prevention of damage of materials due to the ease of access. System 10 is configured at an easy to reach location, especially when compared to ladder racks or equipment racks located on the truck of a roof and/or over the truck bed of a truck.

Furthermore, and in the arrangement shown as one example, system 10 provides a system which can carry large equipment and/or a plurality of ladders in a way which will work even with a small car and/or small vehicle or the like, due to the unique orientation and configurations provided herein.

### User (or Plurality Thereof):

In the arrangement shown, as one example, system 10 includes a user. User 11 may be any user interacting with or utilizing the system 10. This may include viewing, controlling, analyzing, manipulating, and/or interacting with system 10. User 11 is not limited to a single user but may be a plurality of users.

### Vehicle:

In the arrangement shown, as one example, system 10 may also include a vehicle (also referred to as “car”, “truck”, or simply “vehicle”). However, a vehicle 10 is not required for system 10 but included herein for ease of explanation. Vehicle is formed of any suitable size, shape, and design, and is configured to be utilized to hold system 10 and transport the devices stored thereon. Vehicle may be a sport utility vehicle, a trailer, a car, a truck, a hand cart, and the like.

### Hitch:

In the arrangement shown, as one example, system 10 may also include a hitch (also referred to as “tow hitch”, “tow attachment”, or simply “system attachment”). Hitch is formed of any suitable size, shape, and design, and is configured to accept the stem 20 (to be further described herein) of system 10.

In the arrangement shown, as one example, the hitch of a truck is utilized for ease of explanation. In this way, the hitch is an integrated part of the truck and forms a common method of attaching a trailer and the like.

### Stem:

In the arrangement shown, as one example, system 10 includes a stem 20 (also referred to as “hitch attachment”, “base”, or simply “stem”). Stem 20 is formed of any suitable size, shape, and design, and is configured to slide into a hitch and secure system 10 to the hitch of a vehicle.

In the arrangement shown, as one example, stem 20 extends a length from a first end (or hitch end) to a second end (or hinge end) having an exterior surface and a hollow interior. In the arrangement shown, as one example, the stem 20 is formed of a metal and/or steel material and/or alloy and is configured to be strong and durable to support a load therefrom.

### Operable Attachment:

In the arrangement shown, as one example, system 10 includes an operable attachment 40 (also referred to as a “hinged connected”, “a foldable connection”, or simply “connection”). Operable attachment 40 is formed of any suitable size, shape, and design, and is configured to form an adjustable and operable connection from the stem and/or base to the main body of system 10.

In one arrangement, as is shown, the operable connection 40 is formed of a pin and lock system such that the main body of system 10 can be locked into place via a plurality of pin and lock operations. However, operable connection 40 may also be formed of a hinge, a gyroscope, a lever mechanism, and/or other folding mechanisms and/or adjustment mechanisms such that the operable connection provides for ease of easy, easily folding the main body from vertical to horizontal to similar angles, and the like.

Said another way an in the arrangement shown, as one example, the operable attachment 40 includes a stem guide 42 for aligning the main body to the stem 20, the operable attachment 40 includes a first pin 42—for locking the main body 60 into place and/or allowing rotation of the main body 60 about the axis of a second pin 44, a second pin 44 providing for connection of the main body to the operable attachment.

Said another way, in the arrangement shown, as one example, the stem guide 42 is formed of two rectangular bars which are secured to opposing sides of the main body and which align to the opposing sides of the stem. In this way, the operable attachment is secured to the stem via welding or other connections while allowing the main body to rotate about an axis through the center of the second pin.

Furthermore, in the arrangement shown, as one example, a first pin and second pin are utilized for ease of explanation. However, these attachments may be formed from a single rotational function and/or may be a ball joint, a hinged joint, a gyroscope, an adjustable lever, and/or may also include a telescoping extension, and the like.

In the arrangement shown, as one example, system 10 is configured to operate moving from an engaged position (or “transport position”) to a disengaged position (or “unload position”).

Said another way, in an engaged position, the system 10 is upright. The ladders or other devices stored thereon are lifted and/or raised and ready for motion. In this way, the system 10 provides for transporting ladders and/or other large objects easily. Ladders and/or other stored devices can be loaded and/or unloaded when in the engaged position.

Similarly, ladders and/or other devices which are stored can be unloaded in a disengaged position. In the arrangement shown, as one example, system 10 is configured to rotate and/or fold down so that all the ladders and/or devices stored thereon can be easily unloaded simultaneously. This makes the arduous work of lifting heavy objects off of the system and/or lifting objects individually off of the system much simpler and easier. This also makes the process of loading and/or unloading much faster.

Likewise, and in the arrangement shown as one example, objects and/or items can be loaded when the system is in the disengaged position. Once secured and ready, the system can move into an engaged position while fully loaded. It is hereby contemplated for use that the system may also include a hydraulic feature for easily rotating and/or changing the position of the system from an engaged position to a disengaged position, and vis-versa.

### Main Body:

In the arrangement shown, as one example, system 10 includes a Main Body 50 (also referred to as “spine”, “column”, or simply “main body”). Main body 50 is formed of any suitable size, shape, and design, and is configured to act as the primary structure and support of system 10 for which other features attach thereto.

In the arrangement shown, as one example, main body 50 extends a length from a first end 52 (or base end) to a second end 53 (or top end)—having an exterior surface and a hollow interior—with a plurality of securement features 57, a mid attachment 58, and an end attachment 59.

In the arrangement shown, as one example, the main body includes a plurality of securement features 57. These features are for securing the main body to other components. These features also serve to attach other items to the main body. Some of these features may include, but are not limited to ropes, chains, hook and loop, bungee cords, clasps, pins, and the like.

In the arrangement shown, as one example, the main body includes a mid attachment feature 58. The mid attachment feature 58 is formed of any suitable size, shape, and design, and is configured to accept the lower support and secure the lower support to the main body.

In the arrangement shown, as one example, the main body includes an end attachment feature 59. The end attachment feature 59 is formed of any suitable size, shape, and design, and is configured to accept the plurality of upper supports and secure the plurality of upper supports (or “upper support”) to the main body.

In the arrangement shown, as one example, the main body 50 is formed of a metal and/or steel material and/or alloy and is configured to be strong and durable to support a load therefrom. In one arrangement, the main body 50 is formed of c-channel steel or metal. In another arrangement, the main body 50 is formed of square tube steel or metal. This material may also be a polymer, a fiber glass, a fiber enhanced polymer, a polyvinyl chloride, a combination thereof, and the like.

### Lower Support:

In the arrangement shown, as one example, system 10 includes a lower support 70 (also referred to as “mid support”, “first support”, “bottom support”, or simply “holder”). Lower support 70 is formed of any suitable size, shape, and design, and is configured to provide an attachment location for various equipment, such as ladders and the like. Lower support extends a length from a first end to a second end and runs in approximately parallel spaced relation to the main body 50.

In the arrangement shown, as one example, lower support is formed with a plurality of attachment features, grip features, grip surfaces, lock features, and the like.

In the arrangement shown, as one example, the main body 50 is formed of a metal and/or steel material and/or alloy and is configured to be strong and durable to support a load therefrom.

### Upper Support:

In the arrangement shown, as one example, system 10 includes an upper support 80 (also referred to as “second support”, “top support”, or simply “upper support”). Upper support 80 is formed of any suitable size, shape, and design, and is configured to provide an attachment location for various equipment, such as ladders and the like. Upper support extends a length from a first end to a second end and runs in approximately parallel spaced relation to the main body 50.

In the arrangement shown, as one example, upper support is formed with a plurality of attachment features, grip features, grip surfaces, lock features, and the like.

In the arrangement shown, as one example, the upper support 90 is formed of a metal and/or steel material and/or alloy and is configured to be strong and durable to support a load therefrom.

Furthermore, while two primary supports are hereby contemplated for use. Additional supports and adjustable supports are also contemplated for use such as for adjusting for the hauling of various types of cargo and the like.

### Locking Device:

In the arrangement shown, as one example, system 10 may also include a locking device 100. Locking device 100 is formed of any suitable size, shape, and design and is configured to secure the ladders and/or other objects loaded on system 10. Said another, locking device 100 provides for the prevention of unwanted removal of the ladders and/or objects from system 10.

In the arrangement shown, as one example, locking device 100 is formed from a padlock and key set up. In this way, the key is required to remove the padlock and access the ladders loaded onto the system 10. Other locking devices are also hereby contemplated for use. Some examples of other locking devices include, but are not limited to, a pin pad lock, a coded lock, a split beam nut, a castellated nut and split pin, a hex nut and bolt, a remote lock, a mortise lock, a latch lock, a lock plate, an alternative key system, and the like.

In the embodiment including a padlock and key locking device, a bar 102 and/or latch 102 is contemplated. Similarly, a latch catch 104 (also referred to as a “hook” or” ring”) is contemplated for the latch to secure and lock the ladders and/or other objects in place. In this way, the latch slides over the hook and the padlock loops through the hook or ring, preventing the latch from opening and/or removing from the locking position.

### Lights and Power;

In the arrangement shown, as one example, system 10 may also include a plurality of lights, and wiring and plugs for plugging the system into a vehicle.

In the arrangement shown, as one example, system 10 may also include a plurality of lights, and a plurality of batteries for powering those lights.

### Additional Components:

In the arrangement shown, as one example, system 10 also includes a hinge plate 200, a cover plate 201, a plurality of end caps 202, and an end cap with tabs 203, a long plate, a short tube 205, a tube 206, a holed tube 207, a long angled tube 208, a short angled tube 209, and a formed bracket 210.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A carrier system, comprising:
a stem;
the stem extending a length from a first end to a second end;
the stem having an exterior surface;
the stem having a hitch connection;
a main body;
the main body extending a length from a first end to a second end;
the main body having an exterior surface;
the main body having a plurality of securement features;
the main body having an end attachment;
wherein the main body is operably connected to the stem at the first end of the main body;
a lower support;
the lower support extending a length from a first end to a second end;
the lower support having an attachment feature;
wherein the lower support is operably connected to the main body along the length of the main body between the first end of the main body and the second end of the main body;
wherein the lower support is detachable from the main body;
a plurality of upper supports;
each of the plurality of upper supports extending a length from a first end to a second end;
each of the plurality of upper supports having an attachment feature;
wherein each of the plurality of upper supports is operably connected to the main body near at the second end of the main body;
wherein each of the plurality of upper supports are detachable from the main body.

2. The system of claim 1, further comprising:
the stem having a hollow interior.

3. The system of claim 1, further comprising:
whereby the stem is configured to engage a hitch of a vehicle.

4. The system of claim 1, further comprising:
the main body having a hollow interior.

5. The system of claim 1, further comprising:
the main body having a mid attachment.

6. The system of claim 1, further comprising:
the lower support having a grip feature;
the lower support having a lock feature.

7. The system of claim 1, further comprising:
each of the plurality of upper supports having a lock feature.

8. The system of claim 1, further comprising:
each of the plurality of upper supports having a grip feature.

9. The system of claim 1, further comprising:
wherein each of the plurality of upper supports includes a grip feature; wherein the grip feature provides for prevention of objects sliding along the length of each of the plurality of upper supports.

10. The system of claim 1, further comprising:
each of the plurality of upper supports having a hollow interior.

11. The system of claim 1, further comprising:
a locking device;
wherein the locking device is a padlock and key;
a latch;
a latch catch;
wherein the latch is configured to rotate to a closed position; wherein a closed position brings the latch into contact with the latch catch;
wherein the latch is configured to be locked in place by the locking device by securing the latch to the latch catch.

12. The system of claim 1, further comprising:
a latch;
a latch catch;
wherein the latch is configured to rotate to a closed position; wherein a closed position brings the latch into contact with the latch catch.

13. The system of claim 1, further comprising:
wherein the stem is formed of metal tubing.

14. The system of claim 1, further comprising:
wherein the main body is formed of square tube steel.

15. The system of claim 1, further comprising:
a first pin;
the stem having a first through hole;
wherein in the first pin is configured to slide through the first through hole;
wherein the stem is configured to slide into a hitch of a vehicle;
wherein the first pin is configured to slide through the hitch and first through hole;
thereby securing the stem to the hitch;
a second pin;
the stem having a second through hole;
the main body having a first through hole near the first end of the main body;
wherein the second pin is configured to slide through the second through hole of the stem and the first through hole of the main body; whereby the second pin operably attaches the main body to the stem;
wherein the second pin provides an axis about which the main body can rotate relative to the stem;
a securement feature which prevents the main body from rotating about the stem when in an engaged position; wherein when in a disengaged position the securement feature provides for the main body to rotate about the stem.

16. The system of claim 1, further comprising:
a plurality of lights;
wherein the lights are configured to plug into a vehicle.

17. The system of claim 1, further comprising:
a plurality of lights;
a plurality of batteries;
wherein the plurality of batteries are configured to power the plurality of lights.

18. A ladder carry device for attaching to a vehicle, comprising:
a vehicle;
a hitch;
a plurality of ladders;
a stem;
the stem extending a length from a first end to a second end;
the stem having an exterior surface;
the stem having a hitch connection;
a main body;
the main body extending a length from a first end to a second end;
the main body having an exterior surface;
the main body having a plurality of securement features;
the main body having an end attachment;
wherein the main body is operably connected to the stem at the first end of the main body;
a lower support;
the lower support extending a length from a first end to a second end;
the lower support having an attachment feature;
wherein the lower support is operably connected to the main body along the length of the main body between the first end of the main body and the second end of the main body;
wherein the lower support is detachable from the main body;
a plurality of upper supports;
each of the plurality of upper supports extending a length from a first end to a second end;
each of the plurality of upper supports having an attachment feature;
wherein each of the plurality of upper supports is operably connected to the main body near at the second end of the main body;
wherein each of the plurality of upper supports are detachable from the main body.

19. A transportation storage device, comprising:
a stem;
the stem extending a length from a first end to a second end;
the stem having an exterior surface;
the stem having a hollow interior;
the stem having a hitch connection;
whereby the stem is configured to engage a hitch of a vehicle;
a main body;
the main body extending a length from a first end to a second end;
the main body having an exterior surface;
the main body having a hollow interior;
the main body having a plurality of securement features;
the main body having a mid attachment;
the main body having an end attachment;
wherein the main body is operably connected to the stem at the first end of the main body;
a lower support;
the lower support extending a length from a first end to a second end;
the lower support having an attachment feature;
the lower support having a grip feature;
the lower support having a lock feature;
wherein the lower support is operably connected to the main body along the length of the main body between the first end of the main body and the second end of the main body;
wherein the lower support can be removed for desired configurations;
a plurality of upper supports;
each of the plurality of upper supports extending a length from a first end to a second end;
each of the plurality of upper supports having an attachment feature;
each of the plurality of upper supports having a grip feature;
each of the plurality of upper supports having a lock feature;
wherein each of the plurality of upper supports is operably connected to the main body near at the second end of the main body;
wherein each of the plurality of upper supports are detachable from the main body;
a locking device; wherein the locking device is configured to lock objects into place on the system, preventing removing the objects from the system without unlocking the locking device;
a latch;
a latch catch;
wherein the latch is configured to rotate to a closed position; wherein a closed position brings the latch into contact with the latch catch;
wherein the latch is configured to be locked in place by the locking device by securing the latch to the latch catch.

20. The system of claim 19, further comprising:
a hinge plate;
a cover plate;
a plurality of end caps;
an end cap with tabs;
a long plate;
a short tube
a tube;
a holed tube;
a long angled tube;
a short angled tube;
a formed bracket.
